(19) United States
(12) Patent Application Publication
(10) Pub. No.: US 2014/0354652 A1
(43) Pub. Date: Dec. 4, 2014

(54) CHARACTER DRAWING DEVICE AND CHARACTER DRAWING METHOD

(71) Applicants: Hiroyasu Negishi, Tokyo (JP); Takuya Maekawa, Tokyo (JP); Takenori Kawamata, Tokyo (JP)

(72) Inventors: Hiroyasu Negishi, Tokyo (JP); Takuya Maekawa, Tokyo (JP); Takenori Kawamata, Tokyo (JP)

(73) Assignee: Mitsubishi Electric Corporation, Tokyo (JP)

(21) Appl. No.: 14/373,682

(22) PCT Filed: Apr. 27, 2012
(86) PCT No.: PCT/JP12/02918

§ 371 Date: Jul. 22, 2014

(51) Int. Cl. G09G 5/28; G09G 5/24

(52) U.S. Cl. CPC G09G 5/28; G09G 5/24
USPC 345/471

(57) ABSTRACT

A character drawing device includes a system memory that stores outline fonts each defining outlines of characters, and an arithmetic processor that generates rectangles on the outline part of a character shown by an outline font read from the above-mentioned storage, adjusts a width of each of the generated rectangles according to the thickness of the character, and sets a degree of transparency to an inside region of the character which is enclosed by each of the rectangles after the adjustment and a degree of transparency to each of the rectangles to draw the character.

### FIELD OF THE INVENTION

The present invention relates to a character drawing device for and a character drawing method of drawing characters with various weights or performing character formatting with various weights.

### BACKGROUND OF THE INVENTION

A conventional character drawing device prepares two or more types of fonts having different weights, and, when displaying characters having a different weight, such as thick characters or thin characters, switches between fonts according to the weight of characters to be drawn to draw the characters. A problem with this character drawing device is, however, that because the character drawing device needs to have two or more types of fonts, a large-volume memory for storing the fonts is needed.

Therefore, a technology of, in a case in which only a font having one type of weight is mounted and thick characters are displayed, converting the font data into font data having a heavy weight corresponding to the thick characters to draw the characters is known (for example, refer to patent reference 1). According to this technology, in a case in which a font having a maximum weight and a font having a minimum weight are mounted and a font having a weight intermediate between them is used, interpolation is performed on the two fonts to generate a font having a middle weight.

Further, a method of, instead of generating a font having a heavy weight corresponding to thick characters, drawing a general character, and, after that, enclosing the outline part of the character by using a thick line in order to draw a character having a heavy weight at the time of the drawing is also known (for example, refer to patent reference 2).

### RELATED ART DOCUMENTS

### Patent References

Patent reference 1: Japanese Unexamined Patent Application Publication No. 8-263042

Patent reference 2: Japanese Unexamined Patent Application Publication No. 9-34435

### SUMMARY OF THE INVENTION

### Problems to be Solved by the Invention

As mentioned above, a device that, in order to solve the problem that the memory for storing fonts increases because there is a necessity to provide plural types of fonts, is equipped with only a font having one weight, instead of fonts having all weights, and generates a font having another weight from this font is known as a character drawing device.

For example, a character drawing device that has only a font having one weight, moves the outline part of the font outwardly in a vertical direction with respect to the outline when drawing thick characters, and moves the outline part of the font inwardly in a vertical direction with respect to the outline when drawing thin characters is also known. A problem with this device is that the device needs to perform strict calculation on a straight line or a Bezier curve which describes the outline of the font so as not to lose the balance of the outlines of characters, and the process of performing the calculation in real time at the time of drawing characters takes too much time.

Further, a device that, when drawing a character having a heavy weight or a thick character, draws a character having a normal size first and encloses its outline part by using a thick line to implement the drawing is known as another character drawing device. Because the drawing is performed by superposing a thick line on the outline part of a character according to this technology, this technology can be applied to a case of drawing a character having a heavy weight while the technology cannot be applied to a case of drawing a character having a light weight. A further problem is that when making characters be transparent, the degree of transparency differs between superposed portions and non-superposed portions, and characters having a uniform degree of transparency cannot be drawn.

The present invention is made in order to solve the above-mentioned problems, and it is therefore an object of the present invention to provide a character drawing device and a character drawing method capable of performing drawing of characters having different weights or drawing of thick characters with a small memory size and at a high speed.

### Means for Solving the Problem

In accordance with the present invention, there is provided a character drawing device including: a storage that stores outline fonts each defining outlines of characters; and an arithmetic processor that generates rectangles on the outline part of a character shown by an outline font read from the storage, adjusts a width of each of the generated rectangles according to the weight of the character, and sets a degree of transparency to an inside region of the character which is enclosed by each of the rectangles after the adjustment and a degree of transparency to each of the rectangles to draw the character.

### Advantages of the Invention

The character drawing device in accordance with the present invention can perform drawing of characters having different weights or drawing of thick characters with a small memory size and at a high speed.

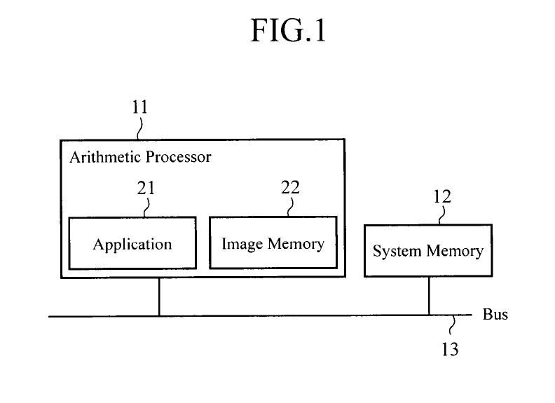

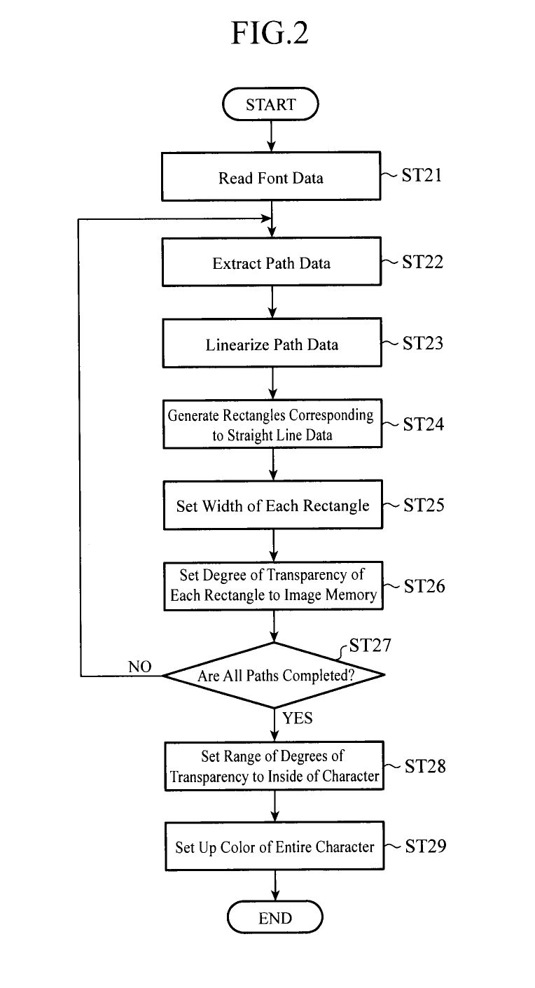

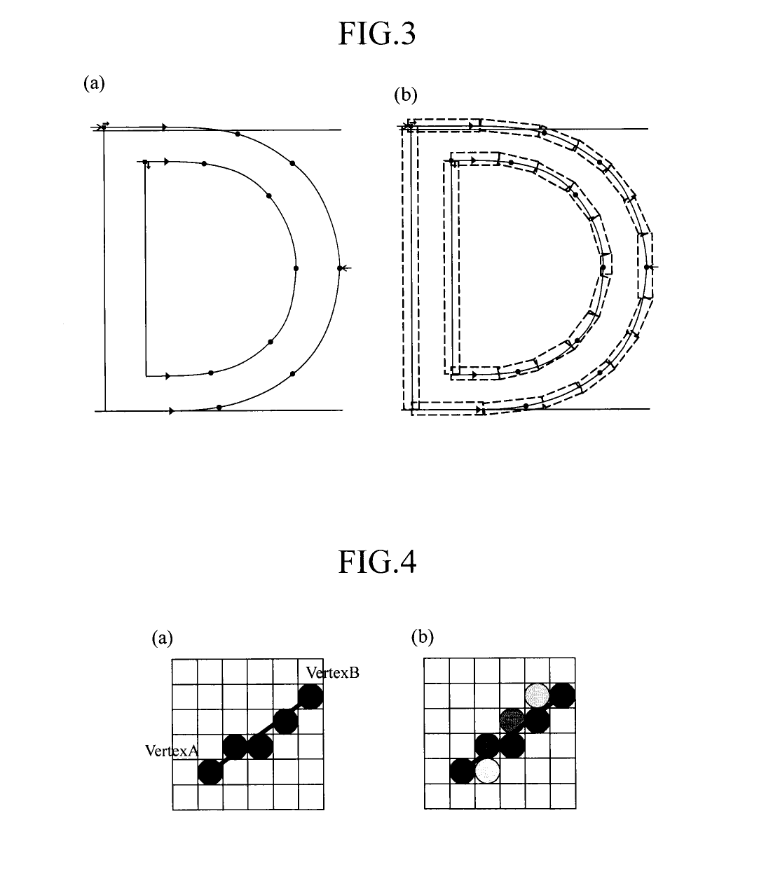

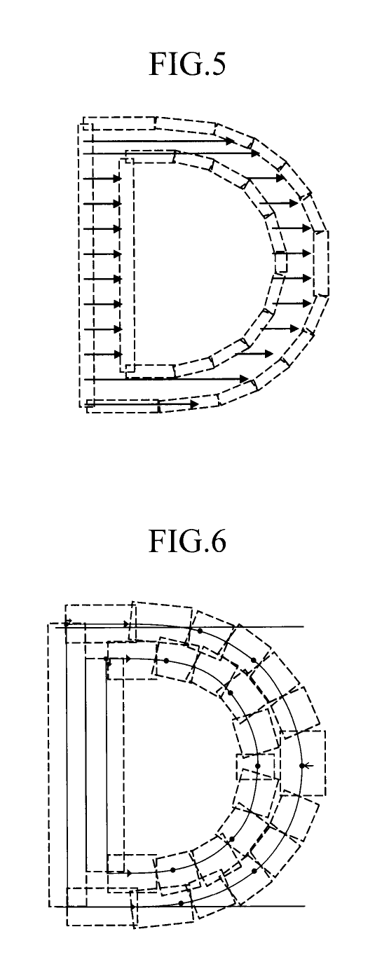

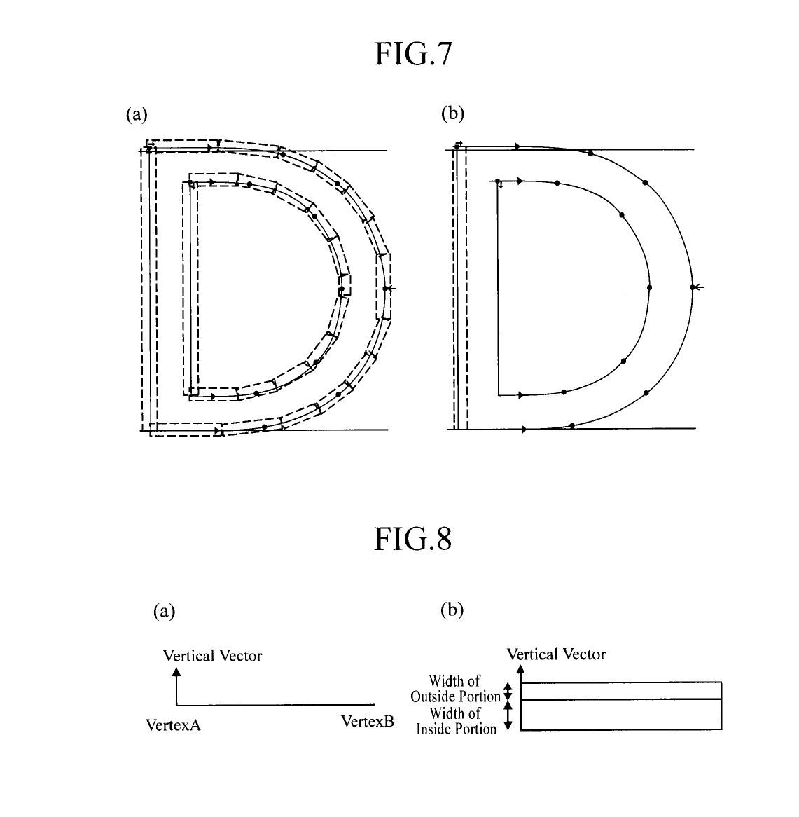

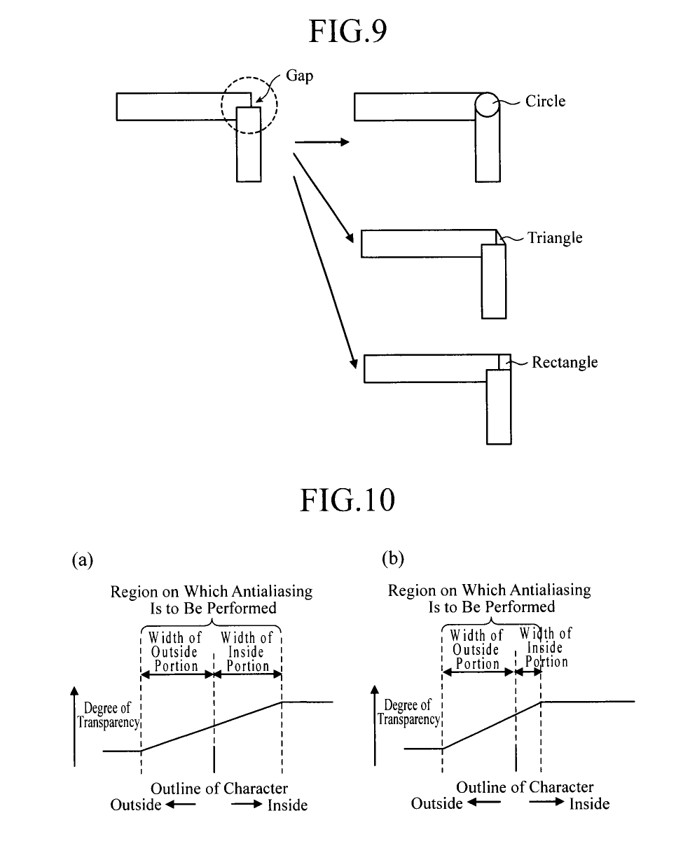

### BRIEF DESCRIPTION OF THE FIGURES

[FIG. 1] FIG. 1 is a block diagram showing the structure of a character drawing device in accordance with Embodiment 1 of the present invention;

[FIG. 2] FIG. 2 is a flow chart showing a drawing process performed by the character drawing device in accordance with Embodiment 1 of the present invention;

[FIG. 3] FIG. 3 is a view for explaining a process of subdiving the outline part of a character into line segments which is performed in the drawing process by the character drawing device in accordance with Embodiment 1 of the present invention;

[FIG. 4] FIG. 4 is a view for explaining an antialiasing process performed in the drawing process by the character drawing device in accordance with Embodiment 1 of the present invention;

[FIG. 5] FIG. 5 is a view for explaining a setup of a range of degrees of transparency to the inside of a character which is performed in the drawing process by the character drawing device in accordance with Embodiment 1 of the present invention;

[FIG. 6] FIG. 6 is a view for explaining generation of a character having a heavy weight in the drawing process by the character drawing device in accordance with Embodiment 1 of the present invention;

[FIG. 7] FIG. 7 is a view for explaining generation of a character having a light weight in the drawing process by the character drawing device in accordance with Embodiment 1 of the present invention;

[FIG. 8] FIG. 8 is a view for explaining calculation of a rectangle having different widths in the drawing process by the character drawing device in accordance with Embodiment 1 of the present invention;

[FIG. 9] FIG. 9 is a view for explaining a method of filling a gap occurring at a joint between thick lines in the drawing process by the character drawing device in accordance with Embodiment 1 of the present invention; and

[FIG. 10] FIG. 10 is a view for explaining a region on which the antialiasing process is to be performed in the drawing process by the character drawing device in accordance with Embodiment 1 of the present invention.

### EMBODIMENTS OF THE INVENTION

Hereafter, the preferred embodiments of the present invention will be explained in detail with reference to the drawings.

### Embodiment 1

FIG. 1 is a block diagram showing the structure of a character drawing device in accordance with Embodiment 1 of the present invention. This character drawing device is constructed by connecting between an arithmetic processor 11 and a system memory 12 via a bus 13.

The arithmetic processor 11 is comprised of, for example, a CPU (Central Processing Unit), and includes an application 21 and an image memory 22. The application 21 consists of a program for implementing functions which this character drawing device has. The image memory 22 stores character image data.

The system memory 12 corresponds to a “storage” in accordance with the present invention, and holds instruction codes which construct the program in the arithmetic processor 11, and data used for various processes. The data held by this system memory 12 include outline fonts each defining the outlines of characters. The storage that stores the outline fonts is not limited to the system memory 12, and the outline fonts can be alternatively stored in a storage included in the arithmetic processor 11.

Next, the operation of the character drawing device in accordance with Embodiment 1 constructed as above will be explained. An operating system (OS) or the like is installed in the above-mentioned arithmetic processor 11, and the arithmetic processor is constructed in such a way that a plurality of applications 21 or a plurality of tasks can run on this OS and a process for implementing the functions as the character drawing device is performed as one of the plurality of applications or tasks.

FIG. 2 is a flow chart showing a drawing process performed by the character drawing device. The drawing process which will be explained hereafter is performed by an application 21 included in the arithmetic processor 11.

In the drawing process, reading of font data is performed first (step ST21). More specifically, the arithmetic processor 11 reads font data which is outline information about characters from the outline fonts stored in the system memory 12.

Extraction of path data is then performed (step ST22). More specifically, the arithmetic processor 11 extracts path data defining the outlines of the characters from the font data read in step ST21. The path data about each character, the path data being included in the font data, is defined by straight lines and/or parametric curves as shown in, for example, FIG. 3(a). As each parametric curve, a quadratic Bezier curve or a cubic Bezier curve is used.

The path data is then linearized (step ST23). More specifically, the arithmetic processor 11 performs a linearization process of subdividing all of the path data consisting of straight lines or curved lines into straight lines. In this step ST23, particularly, each parametric curve is divided into straight lines. For example, the outline part of the character “D” is defined by straight lines and parametric curves as shown in FIG. 3(a).

Then, generation of rectangles corresponding to the straight line data is performed (step ST24). More specifically, the arithmetic processor 11 generates rectangles each having a width from the path data linearized in step ST23. Concretely, each of line segments into which the outline is subdivided is defined as a rectangle, as shown by dashed lines in FIG. 3(b).

A setup of the width of each rectangle is then performed (step ST25). More specifically, the arithmetic processor 11 determines the width of each rectangle generated in step ST24.

The degree of transparency of each rectangle is then set to the image memory (step ST26). More specifically, the arithmetic processor 11 writes the degree of transparency of the character in each rectangle in the image memory 22 as rectangle image data. The degree of transparency written at that time can be a value taking into consideration an antialiasing effect on the outline part of the character.

The antialiasing process is a technology of removing aliasing occurring at the time of drawing a straight line, and FIG. 4(a) shows a straight line on which aliasing exists and FIG. 4(b) shows the straight line on which the antialiasing process is performed. By performing the antialiasing process on the outline part of a character, the character having a smooth outline from which aliasing is removed can be drawn.

In order to implement the antialiasing, each rectangle formed in the outline part is defined as a region on which the antialiasing process is to be performed, and a degree of transparency ranging from 0x00 to 0xFF is set in order to mix a light color into the inside of the rectangle. By writing 0xFF for a portion in which the color of the character is made to come out clearly and writing 0x00 for a portion in which the color of the character is made not to come out, the degree of transparency of each rectangle on which the antialiasing process is to be performed can be set. As a calculation method of calculating the degree of transparency corresponding to the antialiasing, an existing super sampling method or a method according to the distance between the outline and each pixel can be used.

Whether or not all the paths are completed is then checked to see (step ST27). More specifically, determination of whether or not the process on all the paths of the font data read in step ST21 is completed is performed. When it is determined in this step ST27 that all the paths are not completed, the sequence returns to step ST22, and the above-mentioned process is repeated in order to perform the process on the remaining paths.

In contrast, when it is determined in above-mentioned step ST27 that all the paths are completed, a setup of a range of degrees of transparency to the inside of each character is then performed (step ST28). More specifically, the arithmetic processor 11 writes degrees of transparency to the inside of each character of the image data in which a degree of transparency is written to each rectangle formed in the outline part in step ST26, as shown in FIG. 5.

The color of the entire character is then set up (step ST29). More specifically, the arithmetic processor 11 applies a color to the image data in which the degrees of transparency are written to generate a colored character. Concretely, the arithmetic processor 11 sets up the color of the character on the basis of the information about the degrees of transparency of the character completed through the process including up to step ST28 to generate a final character. After that, the character drawing device ends the drawing process.

When generating a character having a different weight, the character drawing device in accordance with this Embodiment 1 can generate a thick character by adjusting the width of each rectangle in above-mentioned step ST25. As shown in FIG. 6, the character drawing device can generate a character having a heavy weight by thickening the width of each rectangle. By making it possible to change the width of each rectangle this way, the character drawing device can use a conventional character drawing logic, just as it is. Therefore, while the processing time required to newly generate font data for each weight becomes unnecessary, and, conversely, the time required for generation of dots corresponding to the thickening increases, a large increase in the basic processing can be avoided.

Further, when generating a character having a light weight, in the setup of the width of each rectangle in step ST25, the character drawing device enables the widths of an inside portion and an outside portion to be set up independently. Although FIG. 7(a) shows a character having a general character width, by decreasing the width of the outside portion, as shown in FIG. 7(b), a character having a light weight which is an entirely small character can be generated. Because the basic processing for the font does not increase also in this case, the processing time does not change greatly.

A rectangle having different widths can be generated by determining a vector connecting between a vertex A and a vertex B as shown in FIG. 8(a), and a perpendicular vector perpendicular to the vector, and calculating points which are moved, as shown in FIG. 8(a), from each of the vertexes by the widths set up along inside and outside directions, respectively. This calculation for the rectangle is the one on a straight line, and the amount of calculation is far smaller than the amount of calculation performed to move a parametric curve outwardly or inwardly in order to increase the size of the font itself.

Further, in the drawing method for use in the character drawing device in accordance with Embodiment 1, although a gap occurs at a joint between thick lines, as shown in a portion enclosed by a dashed circle in FIG. 9, this gap can be removed by drawing a circle at the joint. As an alternative, by drawing a triangle which covers the gap with a lid connecting between the corners of the two thick lines, or drawing a rectangle connecting between the point of intersection of the extended lines of the edges of the two thick lines, and the end of each of the thick lines, the gap can be removed.

Further, when the region of each rectangle is set as a region on which the antialiasing process is to be performed, the antialiasing process is performed between the widths of the outside and inside portions of the character to display a smooth outline, as shown in FIG. 10(a). In this case, because the inside region of the character is increased by decreasing the width of the inside portion, as shown in FIG. 10(b), the size of the entire character does not change, but the inside region which is not transparent increases, and hence a distinct character can be displayed.

Further, by increasing the width of the outside portion of each rectangle, a character whose outline gets blurred can be generated. By temporarily drawing such a character whose outline gets blurred or a character whose outside portion is widened, and drawing a general character (a character in which each rectangle is reduced) overlappedly, an effect such as an outline letter can be produced.

As previously explained, because the character drawing device in accordance with Embodiment 1 of the present invention implements character drawing corresponding to a plurality of weight from a single font, the memory capacity for holding fonts can be reduced. Further, because the character drawing device in accordance with Embodiment 1 of the present invention implements drawing of a character having a different weight or drawing of a thick character by using a general character drawing method without using a method of determining the shape of a font from calculations, the processing time can be shortened.

While the invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

The character drawing device in accordance with the present invention is suitable for a display device or a printer which outputs characters in various computers and so on.

### EXPLANATIONS OF REFERENCE NUMERALS

11 arithmetic processor, 12 system memory, 21 application, 22 image memory.

1. A character drawing device comprising:
a storage that stores outline fonts each defining outlines of characters; and
an arithmetic processor that generates rectangles on an outline part of a character shown by an outline font read from said storage, adjusts a width of each of said generated rectangles according to a thickness of the character, sets a degree of transparency to an inside region of the character which is enclosed by each of the rectangles after said adjustment and a degree of transparency to each of the rectangles to draw the character, and draws a circle at a joint between said rectangles.

2. The character drawing device according to claim 1, wherein the arithmetic processor sets each of the rectangles generated on the outline part of the character as a region on which an antialiasing process is to be performed.

3. The character drawing device according to claim 1, wherein the arithmetic processor makes each of the rectangles generated on the outline part of the character have portions located inside and outside the character and having different widths.

4. The character drawing device according to claim 2, wherein the arithmetic processor makes each of the rectangles generated on the outline part of the character have an inside portion having a small width.

5. The character drawing device according to claim 2, wherein the arithmetic processor makes each of the rectangles generated on the outline part of the character have an outside portion having a large width.

6. The character drawing device according to claim 1, wherein the arithmetic processor makes each of the rectangles generated on the outline part of the character have a large width and draws the character, and, after that, overlappedly draws the character for which each of the rectangles is reduced.

7. A character drawing device comprising the steps of:
generating rectangles on an outline part of a character shown by an outline font defining outlines of characters, adjusting a width of each of said generated rectangles according to a thickness of a character, setting a degree of transparency to an inside region of the character which is enclosed by each of the rectangles after said adjustment and a degree of transparency to each of the rectangles to draw the character, and drawing a circle at a joint between said rectangles.
